(19) United States
(12) Patent Application Publication
(10) Pub. No.: US 2008/0018034 A1
(43) Pub. Date: Jan. 24, 2008

(54) Shock-absorbing rod for bicycle saddles

(76) Inventor: Kuo-Hua Huang, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/700,045

(22) Filed: Jan. 31, 2007

(30) Foreign Application Priority Data
Jul. 3, 2006 (TW) 095211628

(51) Int. Cl. F16F 7/00

(52) U.S. Cl. 267/195

(57) ABSTRACT

The present invention relates to a shock-absorbing rod for bicycle saddles, which essentially consists of an outer tube and an interior tube, wherein the interior tube is inserted into the outer tube. There is hydraulic oil poured on the outer and interior tubes. Furthermore, a resilient body is arranged in the interior tube to support the piston rod connected to a saddle. Accordingly, the user can feel comfortable, even when he/she rides on an uneven road surface, since the shock-absorbing rod can effectively absorb shocks and vibrations resulting from uneven road surfaces.

### BACKGROUND OF THE INVENTION

1. Field of the Invention

The present invention relates to a shock-absorbing rod for bicycle saddles. In particular, the present invention relates to a shock-absorbing rod which is mountable to the bicycle saddle to absorb shocks and vibrations resulting from uneven road surfaces, providing the bicycle rider with more comfort during bicycling.

2. Description of the Prior Art

Bicycles are a popular vehicle for each family. Not only students go to school by bicycle, but also more office workers like to go to office by bicycle due to its being light and handy, mobility, and zero petrol consumption.

Since modern people call for higher and higher life quality, they place more importance on leisure time. Among outdoor activities, bike tours in the countryside are getting more and more popular, because it can advantageously improve the functions of the organs and relax people.

In order to improve stability and comfort during bicycling, it is common to install a shock-absorbing device on the frame. The shock-absorbing device is commonly mounted on the fore or back wheel fork, or a improved shock-absorbing structure is arranged directly under the saddle. Now a barometric shock-absorbing device of a shock-absorbing rod for bicycles is disclosed, having a hollow saddle rod, which passes from the upper side downwards through the upper portion of a hollow outer tube, wherein a hollow interior tube is arranged at the lower portion of the internal space of the outer tube; a fixed mount, which is fixed at the lower portion of the interior tube and possesses screw thread on the interior side; a hollow gas-filling valve basis, on whose outer side screw thread is disposed corresponding to said screw thread, wherein the both screw threads screw together; and a gas-filling valve, which is arranged at the lower portion of the gas-filling valve basis.

However, since the cylinder of the barometric shock-absorbing device usually loses gas, which reduces the shock-absorbing effect; besides, due to instable air pressure, the barometric shock-absorbing device is not capable of bearing greater shocks. Therefore, when the user sitting on the saddle rides the bicycle on a relatively uneven road surface, he may feel uncomfortable.

Regarding the shortcomings of the conventional barometric shock-absorbing device of a shock-absorbing rod for bicycles, the inventor of this invention has been devoted to improving it, supported by his knowledge and experiences in manufacture as well as design of many years, and finally created the present invention.

### SUMMARY OF THE INVENTION

An objective of the present invention is to provide a shock-absorbing rod for bicycle saddles provide the rider with more comfort during riding on uneven road surfaces. In accordance with the present invention, a shock-absorbing rod of a saddle is amounted to a bicycle saddle. The shock-absorbing rod consists of an outer tube and an interior tubes, wherein the interior tube is inserted into the outer tube. There is hydraulic oil poured on the outer and interior tube. Furthermore, a resilient body is arranged in the interior tube to support the piston rod which is connected to the saddle. According to such an embodiment, the user can feel comfortable, even when he/she rides on an uneven road surface, since the shock-absorbing rod can effectively absorb shocks and vibrations resulting from uneven road surfaces.

### BRIEF DESCRIPTION OF THE DRAWINGS

The present invention will be better understood by referring to the accompanying drawings, wherein:

FIG. 1 is a perspective exploded view of the shock-absorbing rod for bicycle saddles according to the present invention.

FIG. 2 is a first cross-sectional view of the shock-absorbing rod for bicycle saddles according to the present invention.

FIG. 3 is a second cross-sectional view of the shock-absorbing rod for bicycle saddles according to the present invention.

FIG. 4 is a first partial cross-sectional view of the shock-absorbing rod for bicycle saddles according to the present invention.

FIG. 5 is a second partial cross-sectional view of the shock-absorbing rod for bicycle saddles according to the present invention.

FIG. 6 is a third partial cross-sectional view of the shock-absorbing rod for bicycle saddles according to the present invention.

### DETAILED DESCRIPTION OF THE PREFERRED EMBODIMENT

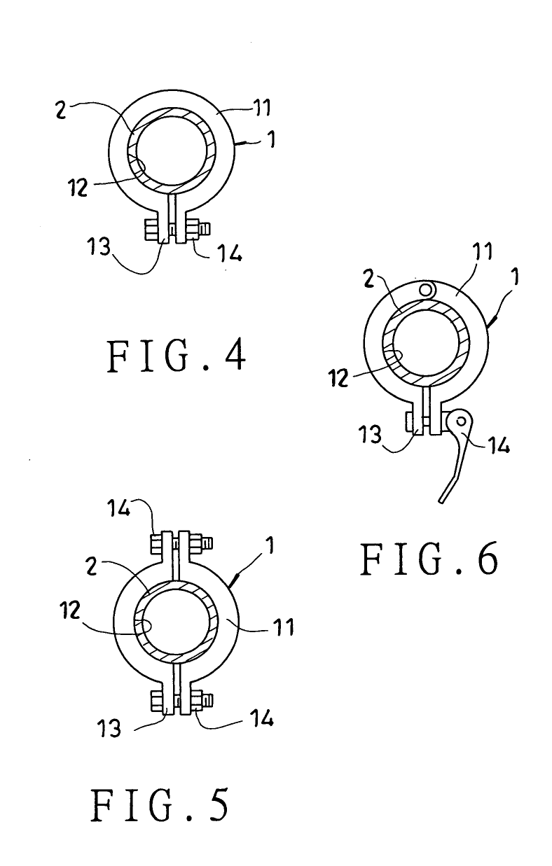

Referring to FIGS. 4-6, a shock-absorbing rod for bicycle saddles in accordance with the present invention comprises a fixed mount 1 of a saddle, which possesses two corresponding washers 11, connected with each other or separately disposed. The corresponding washers 11 are respectively provided with a first through hole 12, in which the shock-absorbing rod 2 of a saddle is movably disposed. There are lugs 13 arranged on one or both sides of the two corresponding washers 11. There are fixing elements 14 passing through the corresponding washers 11, wherein the fixing elements 14 can be sets of screws and nuts, or bolts passing through the lugs 13. An eccentric flange can be pivotally mounted on the bolt for pressing the two washers 11 and taking them apart quickly. Thus, the looseness and tightness of the fixed mount 1 of a saddle can be adjusted so that the length of the outward protrusion of the shock-absorbing rod 2 in the fixed mount 1 can be further adjusted. Then a saddle 3 is mounted to the upper end of the shock-absorbing rod 2 for sitting.

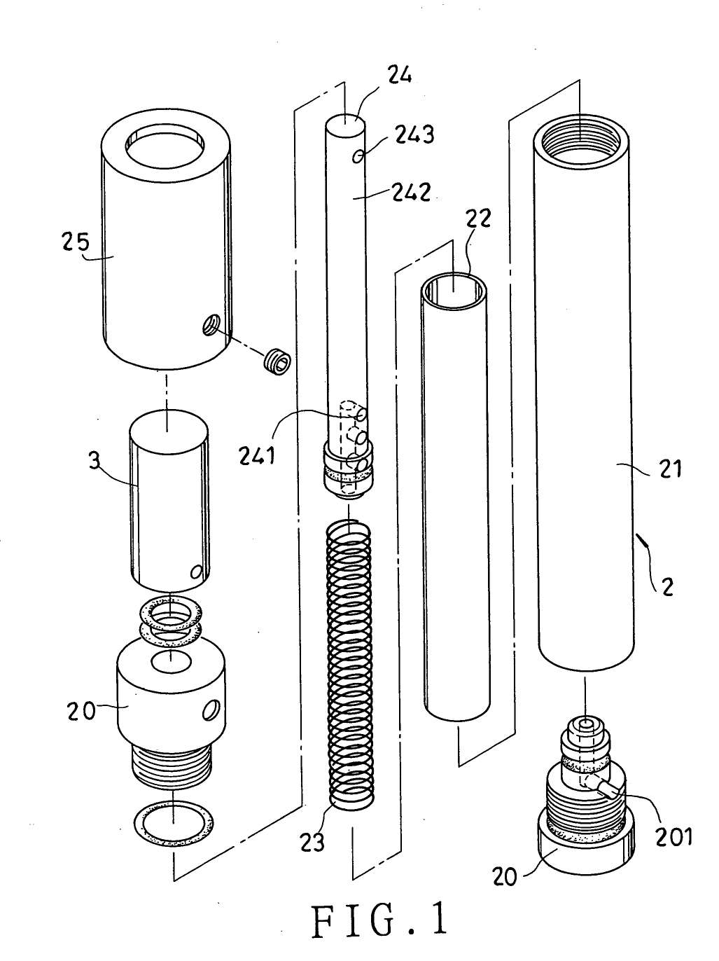

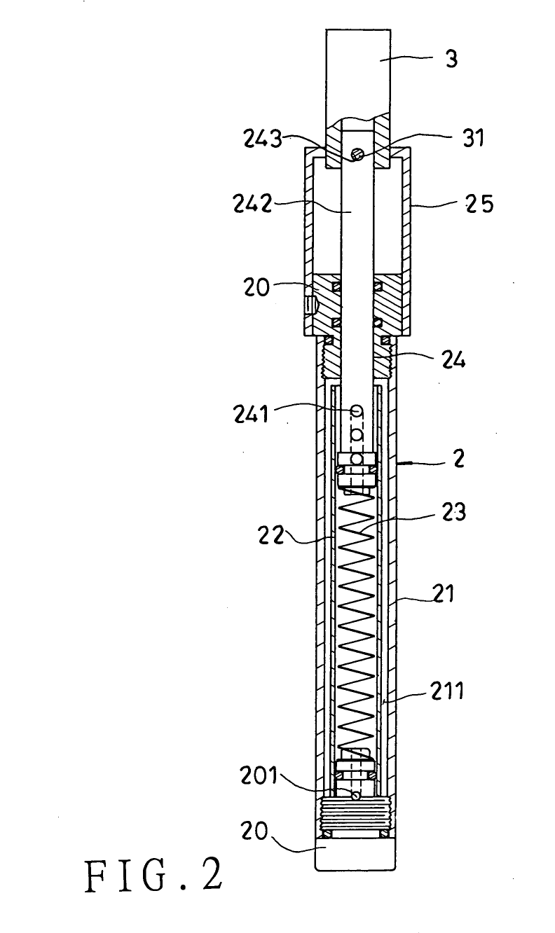

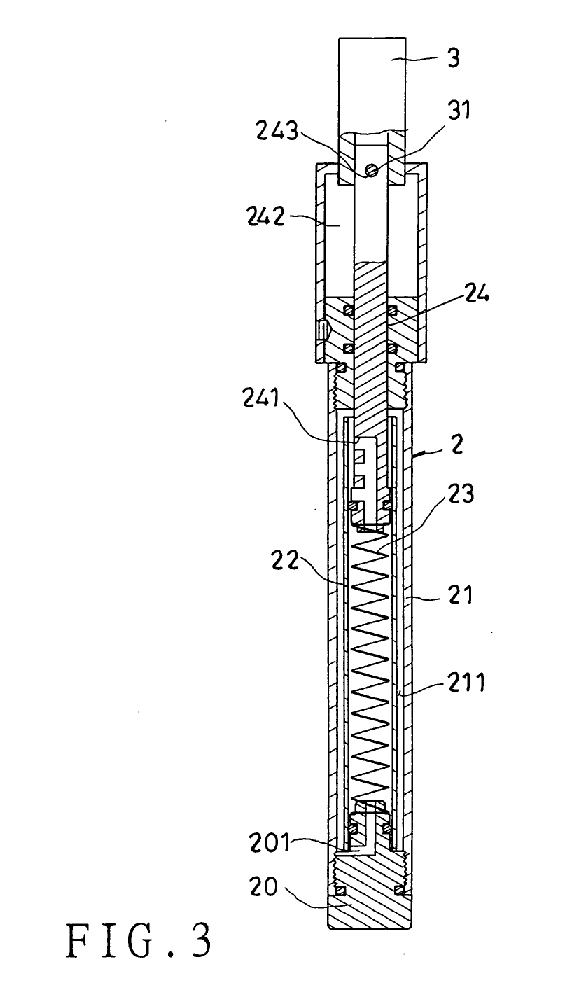

As illustrated in FIG. 1, the shock-absorbing rod 2 comprises an outer tube 21, in which an interior tube 22 is inserted such that the bottom end of the interior tube 22 is correspondingly fixed to the sealing cover 20 screwed on the bottom end and the outer tube 21. Referring to FIG. 2, the sealing cover 20 comprises an oil inlet hole 201. The hydraulic oil flows from the oil receptacle 211 between the outer tube 21 and the interior tube 22 through the said oil inlet hole 201 into the interior tube 22. A resilient body 23 is arranged in the interior tube 22 and supports a piston rod 24. There is an oil outlet hole 241 opened from the bottom of said piston rod 24 toward a lateral side as referred to FIG. 3. Meanwhile, a second through hole 243 is arranged at a appropriate position of a protrusion section 242, which is defined as a section of the piston rod 24 protruding out of the interior tube 22 and the outer tube 21. The second through hole 243 is arranged for the bolt 31 of the saddle 3 to pass through it and be tightly screwed. Moreover, a sleeve 25, being connected to the sealing cover 20 on the upper end of the outer tube 21, can be put on the protrusion section 242 of the piston rod 24 to stabilize the operation of the piston rod 24.

Referring to FIG. 3, when a rider rides a bicycle on an uneven road surface, he/she may feel the shocks resulting therefrom. At this moment the piston rod 24 of the shock-absorbing rod 2 will operate upwardly and downwardly due to the shocks. When the piston rod 24 moves down to press the resilient body 23, it will press the hydraulic oil in the interior tube 22 at the same time in a way that the hydraulic oil flows through the oil outlet hole 241 into the oil receptacle 211 between the interior tube 22 and outer tube 21. With the upward movement of the piston rod 24, the hydraulic oil in the oil receptacle 211 is sucked through the oil inlet hole 201 of the sealing cover 20 into the interior tube 22. In this way, an oil flow circulation is formed. The hydraulic oil stabilizes and absorbs the shocks so that the user can feel comfortable, even when he rides on an uneven road surface.

According to the structure and embodiment described above, following advantages can be obtained by the present invention:

1. The shock-absorbing rod for bicycle saddles in accordance with the invention uses hydraulic oil for absorbing shocks to provide the user with more comfort during riding. Hydraulic oil does not tend to leak, and the oil pressure is stable. These two characteristics contribute to optimal shock-absorbing effects of the shock-absorbing rod for bicycle saddles in accordance with the invention.

2. In accordance with the present invention, a sleeve is connected with the outer tube and disposed on the protrusion section of the piston rod to stabilize and position the operation of the piston rod. The protrusion section is defined as the section of the piston rod protruding out of the interior tube and the outer tube.

What is claimed is:

1. A shock-absorbing rod for bicycle saddles, essentially comprising a fixed mount on the upper of the frame for the movable fitting of the shock-absorbing rod therein, wherein
The shock-absorbing rod is provided with an outer tube, the lower and upper ends of which are locked with first and second sealing covers for the firm insertion of an interior tube therein, an oil receptacle being formed between the outer and interior tubes and injected with hydraulic oil, an oil inlet hole opened on a appropriate position of said first sealing cover for the hydraulic oil inside the oil receptacle flowing into said interior tube, a resilient body arranged in said interior tube for supporting a piston rod, an oil outlet hole opened from the bottom of said piston rod toward a lateral side and a saddle secured fitted on an appropriate position of a protrusion section, which is sticking out of said interior and outer tubes.

2. A shock-absorbing rod for bicycle saddles as claimed in claim 1, wherein a sleeve is covered on said protrusion section of said piston rod, and connected to said second sealing cover locked on said outer tube.

3. A shock-absorbing rod for bicycle saddles as claimed in claim 1, wherein said fixed mount has two corresponding washers each with a first through hole for said shock-absorbing rod movably disposing therein and with lugs on one sides thereof for fixing elements passing therethrough.

4. A shock-absorbing rod for bicycle saddles as claimed in claim 3, wherein said fixing elements can be sets of screws and nuts.

5. A shock-absorbing rod for bicycle saddles as claimed in claim 3, wherein said fixing elements can be an eccentric flange pivotally mounted on said bolt passing through said lugs for pressing said two washers and taking them apart quickly.

6. A shock-absorbing rod for bicycle saddles as claimed in claim 1, wherein said fixed mount has two corresponding washers each with a first through hole for said shock-absorbing rod movably disposing therein and with lugs on both sides thereof for fixing elements passing therethrough.

7. A shock-absorbing rod for bicycle saddles as claimed in claim 6, wherein said fixing elements can be sets of screws and nuts.

8. A shock-absorbing rod for bicycle saddles as claimed in claim 6, wherein said fixing elements can be an eccentric flange pivotally mounted on said bolt passing through said lugs for pressing said two washers and taking them apart quickly.
